(19) United States
(12) Patent Application Publication
(10) Pub. No.: US 2016/0189205 A1
(43) Pub. Date: Jun. 30, 2016

(54) VALIDATION OF BOTTOM-UP ATTRIBUTIONS TO CHANNELS IN AN ADVERTISING CAMPAIGN

(71) Applicants: Anto Chittilappilly, Waltham, MA (US); Payman Sadegh, Alpharetta, GA (US); Darius Jose, Thrissur (IN)

(72) Inventors: Anto Chittilappilly, Waltham, MA (US); Payman Sadegh, Alpharetta, GA (US); Darius Jose, Thrissur (IN)

(21) Appl. No.: 14/585,728

(22) Filed: Dec. 30, 2014

(51) Int. Cl. G06Q 30/02

(52) U.S. Cl. CPC G06Q 30/0246

(57) ABSTRACT

A method, system, and computer program product for forming and validating a predictive model. The predictive model is based on empirically-determined data taken from one or more user encounters. A first portion of a set of user data corresponds to a first set of respective users that have performed at least some first conversion activity after experiencing a touchpoint encounter. A second set of user data corresponds to second respective users that have experienced at least one of the touchpoint encounters. The user data from the first portion are parsed to identify characteristics that are used for calculating propensity to convert scores. The cookies and scores are used to generate a predictive model that forms a prediction for a given user to convert. The predictive model is validated by comparing the predictions to empirically-determined conversion data (e.g., taken from the second set of user data).

### RELATED APPLICATIONS

The present application relates to the subject matter of co-pending U.S. patent application Ser. No. 13/492,493 entitled “METHOD AND SYSTEM FOR DETERMINING A TOUCHPOINT ATTRIBUTION” (Attorney Docket No. VISQ.P0001), filed Jun. 8, 2012 which is hereby incorporated by reference in its entirety.

### FIELD OF THE INVENTION

The disclosure relates to the field predicting user responses to media stimulus. More particularly this disclosure is related to techniques for generating statistically accurate user behavior predictions.

### BACKGROUND

Advertisers want to reach large populations (e.g., through mass marketing such as broadcast channels) in order to build brand awareness and stimulate prospects to make purchase decisions. Sometimes advertisers will use certain types of channels in order to generate interest in a prospective buyer and, often, advertisers set up conditions or promotions to foster action taken by a prospective buyer in the hope that such actions will produce a desired result such as making a “buy” decision.

Generally, only some individuals from among the aforementioned large populations will ever have enough brand awareness to take interest, and only some of those individuals who take initial interest will further take enough interest to be compelled to take action. Yet, the advertiser bears all or most of the costs of the campaign regardless of how many or few prospects are susceptible to particular media suggestions. Some media types such as broadcast media are effective to generate awareness. Other media outlets such as web advertising or other advertising that uniquely identifies an individual receiving the message can serve to move an individual from a state of awareness to a state of interest and finally be motivated to take action (e.g., buy something).

In a single media campaign, there may be many outlets such as web advertising or other advertising that uniquely identifies an individual, and each of these outlets or touchpoints may contribute to stimulating the user to take action; however, even though it can be known unambiguously that a particular user took an action (e.g., to make a “buy” decision, and to effect a purchase) at “the last” of a series of touchpoints in a touchpoint stack, it is not known precisely (e.g., to the specificity of a particular user) and unambiguously (e.g., to a particular degree of certainty) which of the other touchpoints in the touchpoint stack had contributed to moving the user to make the buy decision.

As aforementioned, and relying only on legacy techniques, it cannot be known precisely (e.g., to a user) which of the touchpoints contributed to the user to make the buy decision. However, using the techniques described herein, it can be known to a statistical degree of certainty what portion of a set of users served by a particular touchpoint were likely to convert. With such information, the touchpoint or touchpoints that precede an eventual “buy” decision can be compensated for their contribution to the user's action (e.g., to make a purchase).

Further, knowing to a statistical degree of certainty what portion of a set of users served by a particular touchpoint are likely to convert can aid in improving an ad serving strategy. For example, in managing an advertising and media campaign, an advertiser would want to know if a particular person is susceptible (or immune) to a particular advertising channel and/or media characteristic, and the advertiser would want to tailor the campaign (e.g., tailor the spending in the campaign, tailor the media mix, tailor touchpoint selections, etc.) to improve the likelihood of reaching qualified prospects who will eventually take action (e.g., make a “buy” decision, or make a purchase).

When using certain mass marketing media outlets such as broadcast channels, the susceptibility of the audience might be known in aggregate and/or from demographics (e.g., people who live in Arkansas are not likely to be susceptible to advertisements for “Grand Opening of Luxury Condos in San Francisco”). However some advertising channels are configurable so as to specifically target certain audiences sharing particular demographics. For example, web-based display advertising might be configured to display an ad pertaining to “Grand Opening of Luxury Condos in San Francisco” only to audience members who have a college degree and currently reside within 50 miles of San Francisco. Often, such advertising channels or touchpoints are configured to collect aspects of actual actions taken by a user. For example, a user browsing at a shopping site using a web browser might be presented with an advertisement at “just the right time” and thus be motivated to take action corresponding to the messaging of the presented advertisement. In such a case, the advertiser's advertisement achieves the intended result of the ad placement.

In another situation a different user browsing at the same shopping site might be presented with the same advertisement and yet experience an adverse reaction. The adverse reaction might be correlated to the user's immunity to the media or messaging of the advertisement. Indeed, some users will never make a “buy” decision for the product or service being advertised, and some users will make a “buy” decision regardless of the presence or lack of any aspects or characteristics of the presented media. Still other users will make a “buy” decision only after forming a positive brand awareness or only after being motivated by media to take certain actions toward a buy decision.

Unfortunately, prediction of a particular single user's propensity to respond in a particular manner to a particular stimulus suffers from a high error rate when the prediction is done based on a single user's characteristics or attributes. Yet, if predictions for a single user are based on the actual observed behaviors of a group of users having similar propensities, then the selection of media to present to a given user can be done with the confidence that at least a known percentage of users with the same characteristics will be responsive.

What is needed is a technique or techniques to make propensity predictions for a single user that characterizes the behavior of such a single user based on the actual empirical measurements of actions taken by a larger, more statistically significant group of users that share similar propensity predictions.

None of the aforementioned legacy approaches achieve the capabilities of the herein-disclosed techniques for generating and validating statistically accurate user behavior predictions. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for generating and validating statistically accurate user behavior predictions.

Some embodiments are directed to techniques for predicting a likelihood of conversion (e.g., using a propensity to convert score). Some embodiments implement a predictive model based on empirically-determined data (e.g., cookies) taken from one or more user encounters with an advertising touchpoint. One technique commences by selecting a first portion (e.g., a smaller portion) of a set of cookies and selecting a second portion (e.g., a larger portion) of the set of cookies, where the first portion of the set of cookies corresponds to a first set of respective users that have performed at least a first conversion activity after experiencing a touchpoint encounter and where the second portion of the set of cookies corresponds to a second set of respective users that have experienced at least one of the touchpoint encounters. The cookies from the first portion of the set of cookies are parsed to identify a set of quantifiable characteristics, which are used for determining propensity to convert scores. The cookies and scores are used to generate a predictive model that forms a prediction for a given user to convert. The predictive model is validated by comparing the predictions to empirically-determined conversion data (e.g., cookies for users that are known to have converted and/or cookies for users that are known to have not yet converted).

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A presents an advertising system environment.

FIG. 1B is a decision-making flow to determine touchpoint attribution based on score and confidence thresholds as used in systems configured for generating statistically accurate user behavior predictions, according to some embodiments.

FIG. 1C is a decision-making flow to determine spending based on score and confidence thresholds as used in systems configured for generating statistically accurate user behavior predictions, according to some embodiments.

FIG. 1D is a protocol 1D00 for using statistically accurate user behavior predictions, according to some embodiments.

FIG. 1E presents a system for generating and validating a model to be used with a predictor subsystem configured for generating statistically accurate user behavior predictions, according to some embodiments.

FIG. 2A is a user propensity chart used in calibrating systems for generating statistically accurate user behavior predictions, according to some embodiments.

FIG. 2B is a diminishing returns chart for modeling user behavior changes over time as used for calibrating systems capable of generating statistically accurate user behavior predictions, according to some embodiments.

FIG. 2C is a state progression chart showing user progression over time as is used for calibrating systems capable of generating statistically accurate user behavior predictions, according to some embodiments.

FIG. 3 is a touchpoint attribute chart showing sample attributes associated with sample touchpoints as used in systems capable of generating statistically accurate user behavior predictions, according to some embodiments.

FIG. 4A exemplifies a model generation flow resulting in a predictor capable of generating statistically accurate user behavior predictions, according to some embodiments.

FIG. 4B exemplifies a model validation flow for comparing predictors capable of generating statistically accurate user behavior predictions, according to some embodiments.

FIG. 4C exemplifies a predictor validation system using propensity score pools for generating statistically accurate user behavior predictions, according to some embodiments.

FIG. 4D depicts a subsystem including a confidence interval calculator as used in systems for generating statistically accurate user behavior predictions, according to some embodiments.

FIG. 4E depicts a subsystem including a confidence interval calculator as used in systems for generating statistically accurate user behavior predictions, according to some embodiments.

FIG. 5 is a block diagram of a system for generating statistically accurate user behavior predictions, according to some embodiments.

FIG. 6 depicts a block diagram of an instance of a computer system suitable for implementing an embodiment of the present disclosure.

### DETAILED DESCRIPTION

### Overview

Advertisers want to reach large populations (e.g., through mass marketing such as broadcast channels) in order to build brand awareness and stimulate prospects to make purchase decisions. Sometimes advertisers will use certain types of channels in order to generate interest in a prospective buyer and, often, advertisers set up conditions or promotions to foster action taken by a prospective buyer in the hope that such actions will produce a desired result such as making a “buy” decision.

Generally, only some individuals from among the aforementioned large populations will ever have enough brand awareness to take interest, and only some of those individuals who take initial interest will further take enough interest to be compelled to take action. Yet, the advertiser bears all or most of the costs of the campaign regardless of how many or few prospects are susceptible to media suggestions are also susceptible to be moved from a state of awareness to a state of interest and finally be motivated to take action (e.g., buy something).

In managing an advertising and media campaign, an advertiser would want to know if a particular person is susceptible (or immune) to a particular advertising channel and/or media characteristic, and the advertiser would want to tailor the campaign (e.g., the spending in the campaign) to improve the likelihood of reaching qualified prospects who will eventually take action (e.g., make a “buy” decision, or make a purchase).

When using certain mass marketing media outlets such as broadcast channels, the susceptibility of the audience might be known in aggregate and/or from demographics (e.g., people who live in Arkansas are not likely to be susceptible to advertisements for “Grand Opening of Luxury Condos in San Francisco”). However some advertising channels are configurable so as to specifically target certain audiences sharing particular demographics. For example, web-based display advertising might be configured to display an ad pertaining to “Grand Opening of Luxury Condos in San Francisco” only to audience members who have a college degree and currently reside within 50 miles of San Francisco. Often, such advertising channels or touchpoints are configured to collect aspects of actual actions taken by a user. For example, a user browsing at a shopping site using a web browser might be presented with an advertisement at “just the right time” and then be thus motivated to take action corresponding to the messaging of the presented advertisement. In such a case the advertiser's advertisement achieves the intended result of the ad placement.

In another situation a different user browsing at the same shopping site might be presented with the same advertisement and yet experience an adverse reaction. The adverse reaction might be correlated to the user's immunity to the media or messaging of the advertisement. Indeed, some users will never make a “buy” decision for the product or service being advertised, and some users will make a “buy” decision regardless of the presence or lack of any aspects or characteristics of the presented media. Still other users will make a “buy” decision only after forming a positive brand awareness or only after being motivated by media to take certain actions toward a buy decision.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

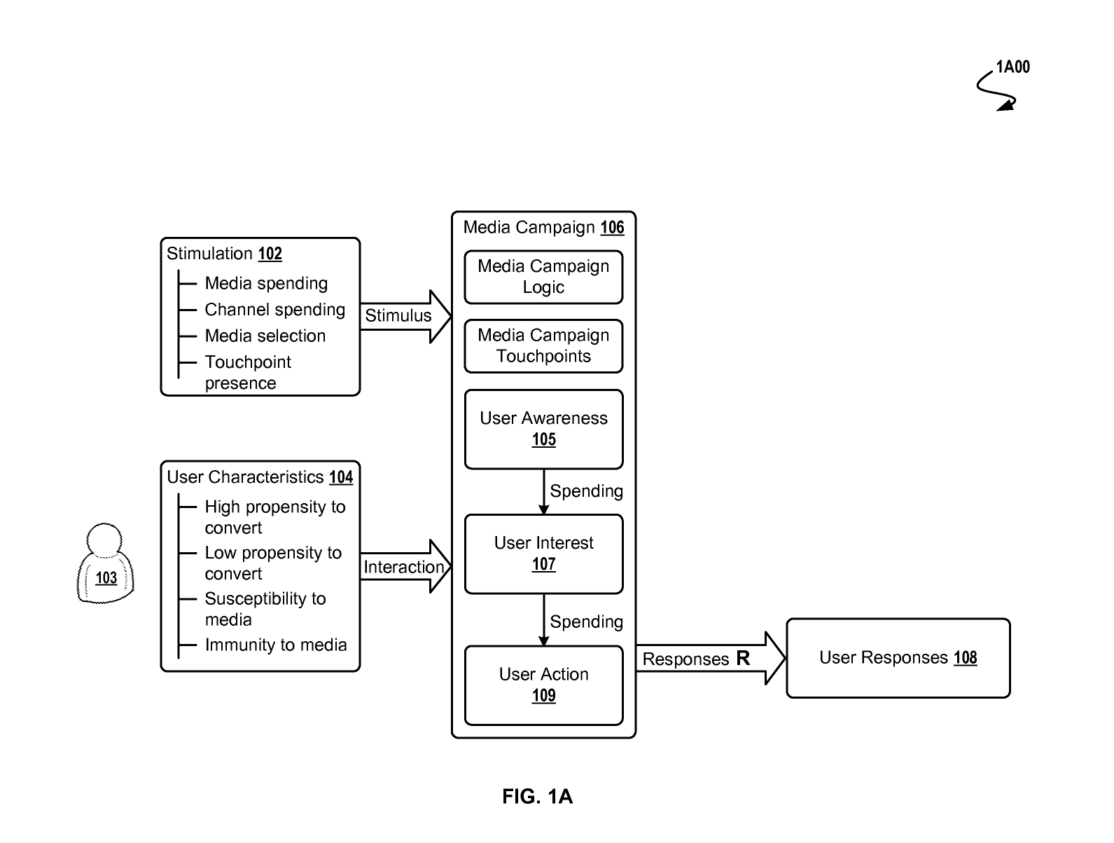

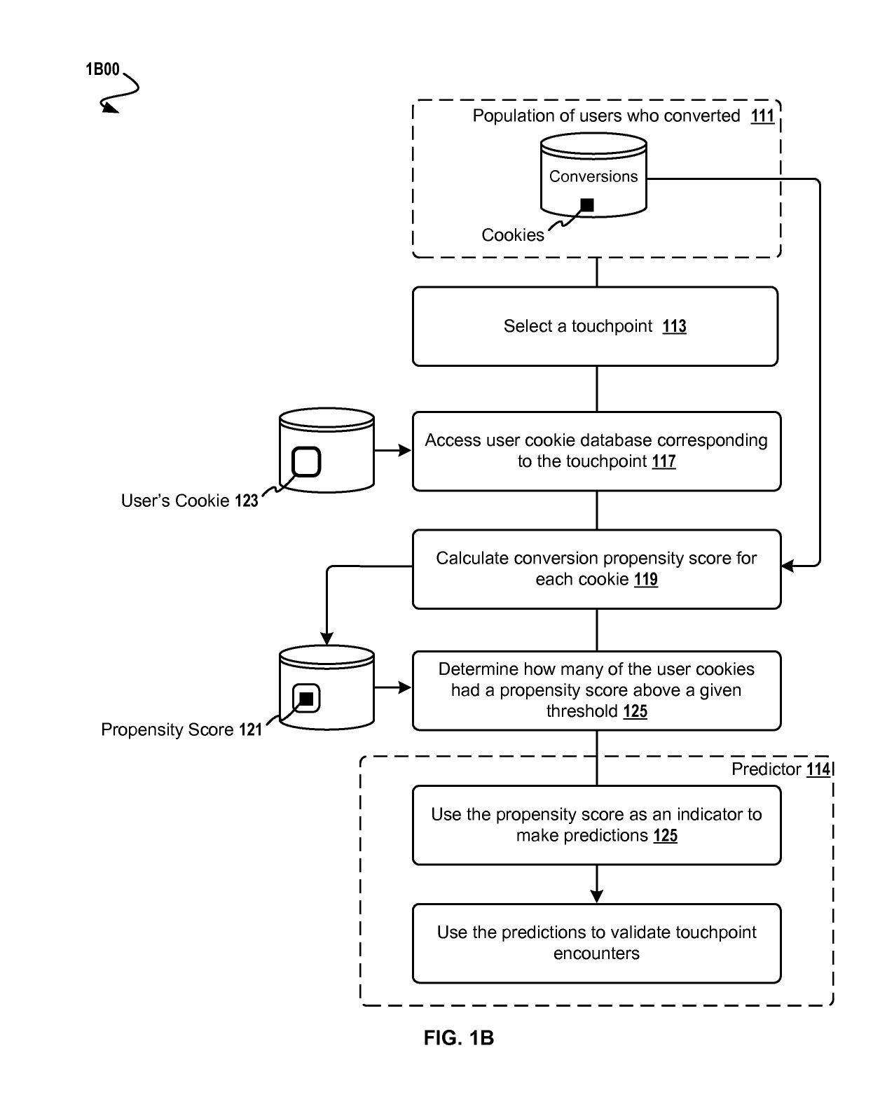

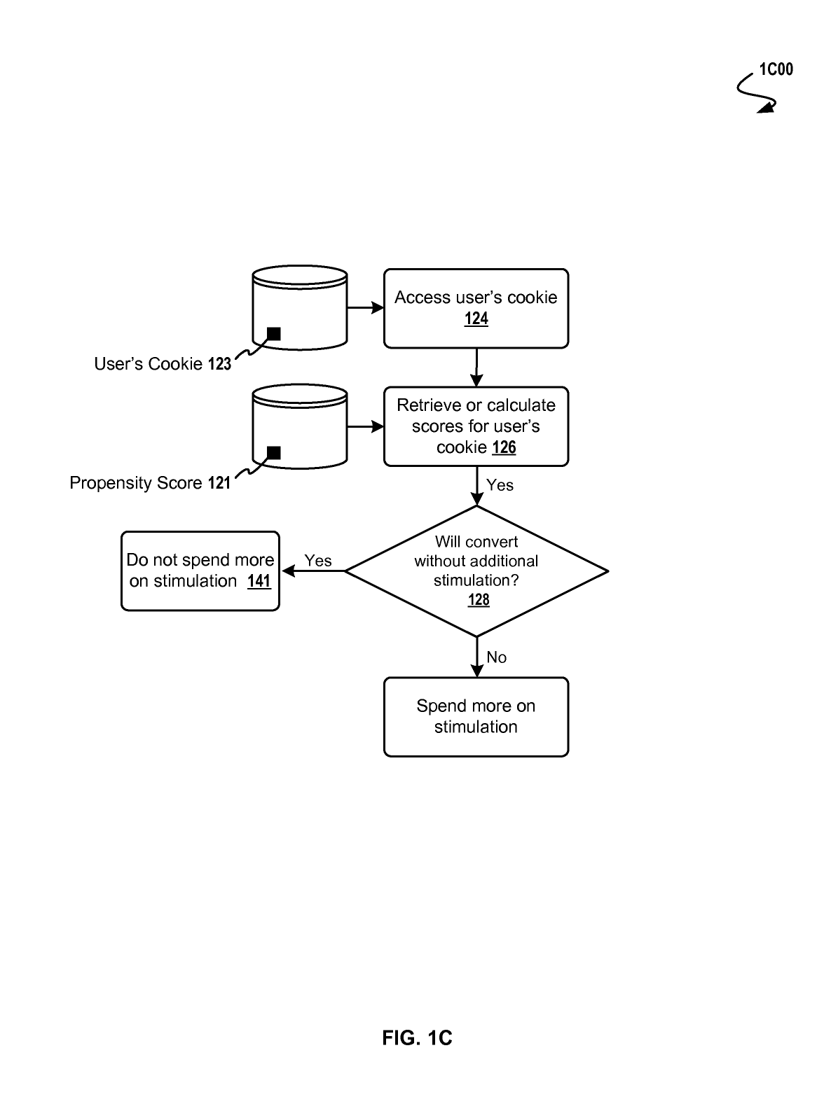

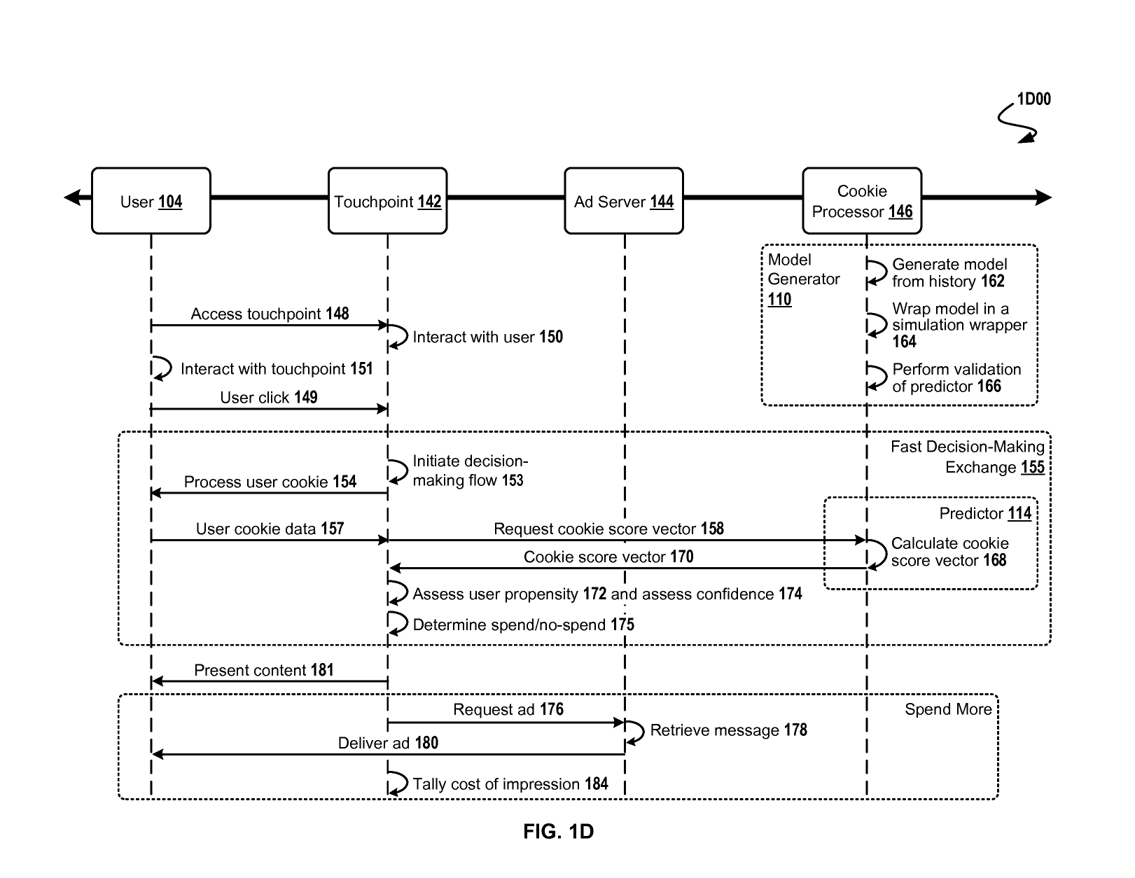

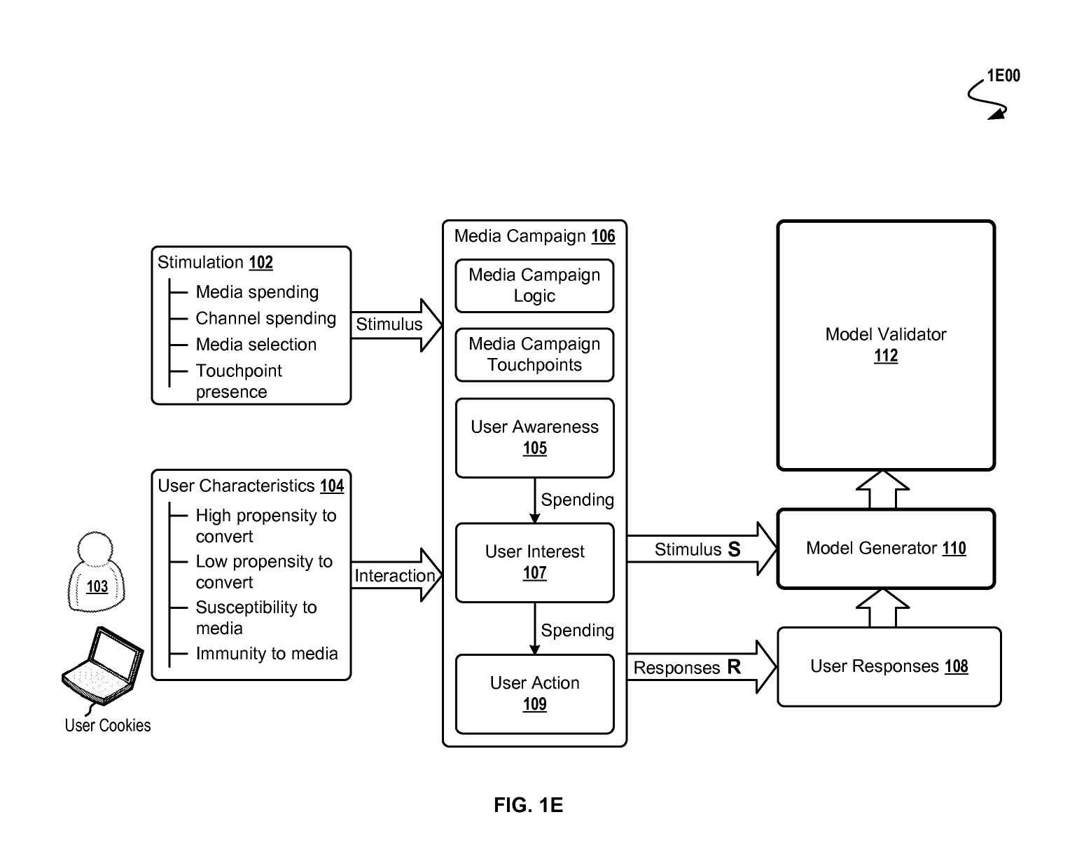

FIG. 1A presents an advertising system environment 1A00. Any component of the advertising system environment 1A00 or any aspect thereof may be implemented in any desired environment.

As shown, the media campaign 106 takes in stimulation 102. A user 103 having a set of user characteristics 104 interacts with aspects of the media campaign, and such interaction results in user responses 108. In some cases, a media campaign is designed such that during the course of interacting with a media campaign, a user achieves user awareness 105. In some cases, a particular user might progress from a state of awareness to a state of user interest 107, and in some cases, a user will progress still further, from merely having some interest to actually taking some user action 109.

The aforementioned stimulation can come in many forms, including media spending (e.g., placing TV spots or radio spots), channel spending (e.g., promotions, contests, commissions, bonuses, etc. paid to participants in the channel), media mix and/or coordination (e.g., a direct mailer piece sent the same week as a radio ad spot blitz), and touchpoint presence (e.g., showing internet display ads in larger geographic areas and/or across more demographics and/or showing internet display ads more frequently or more prominently).

In some cases, using the techniques described hereunder, the contribution of a touchpoint to the occurrences of a population of users who converted can be known to a statistical degree of certainty. Thus an advertiser or agent can determine what portion of a set of users served by a particular touchpoint did convert, and the advertiser or agent can fairly recognize the touchpoint for its contribution.

FIG. 1B is a decision-making flow 1B00 to determine touchpoint attribution based on score and confidence thresholds as used in systems configured for generating statistically accurate user behavior predictions, according to some embodiments.

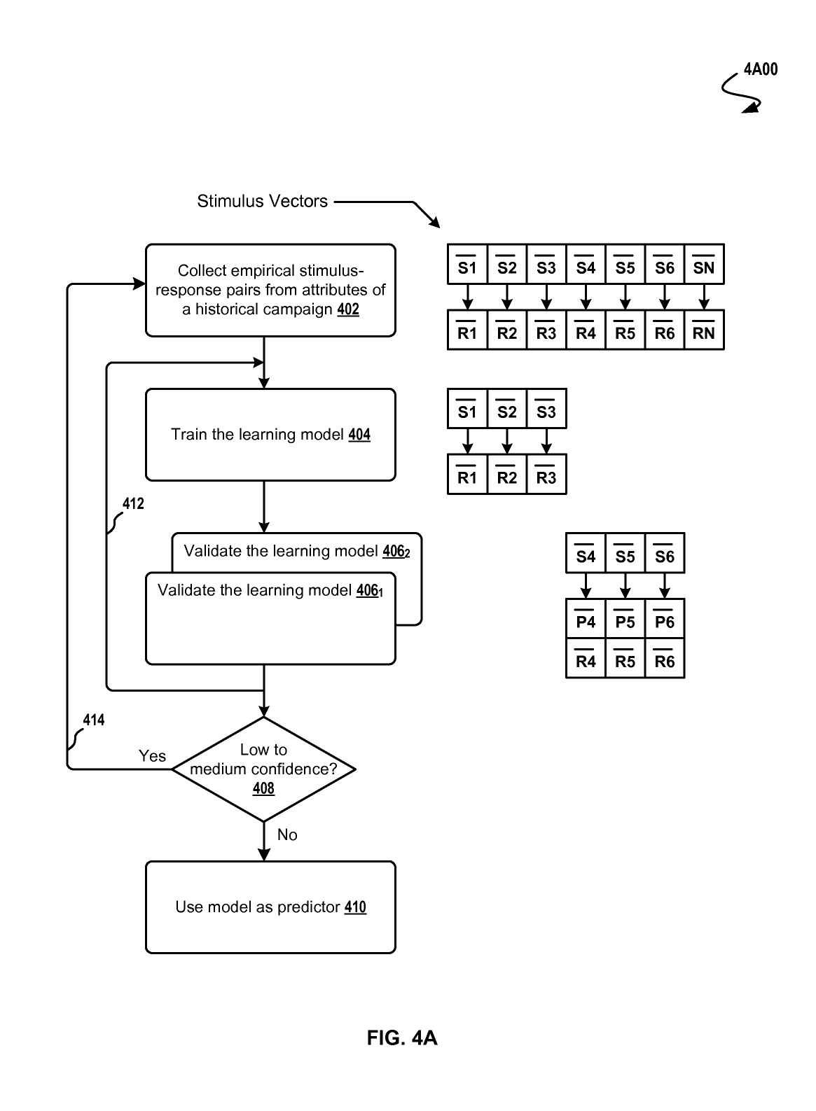

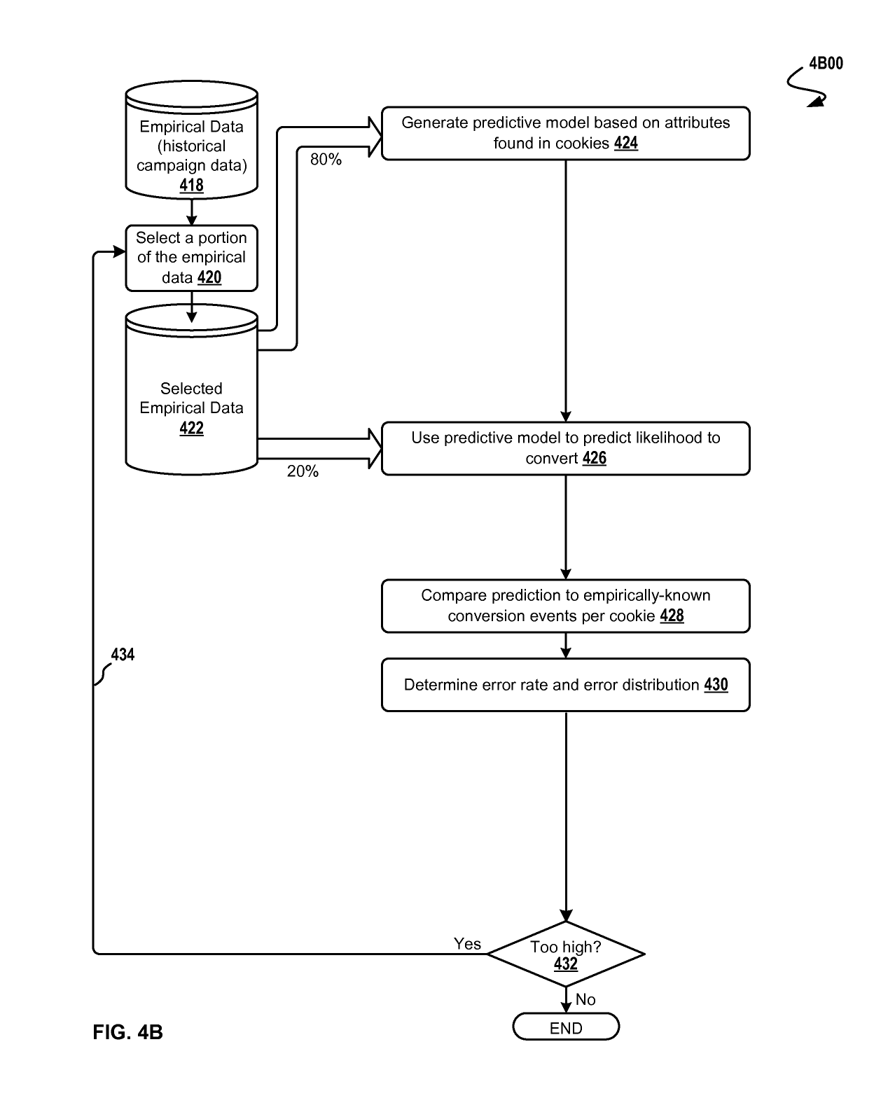

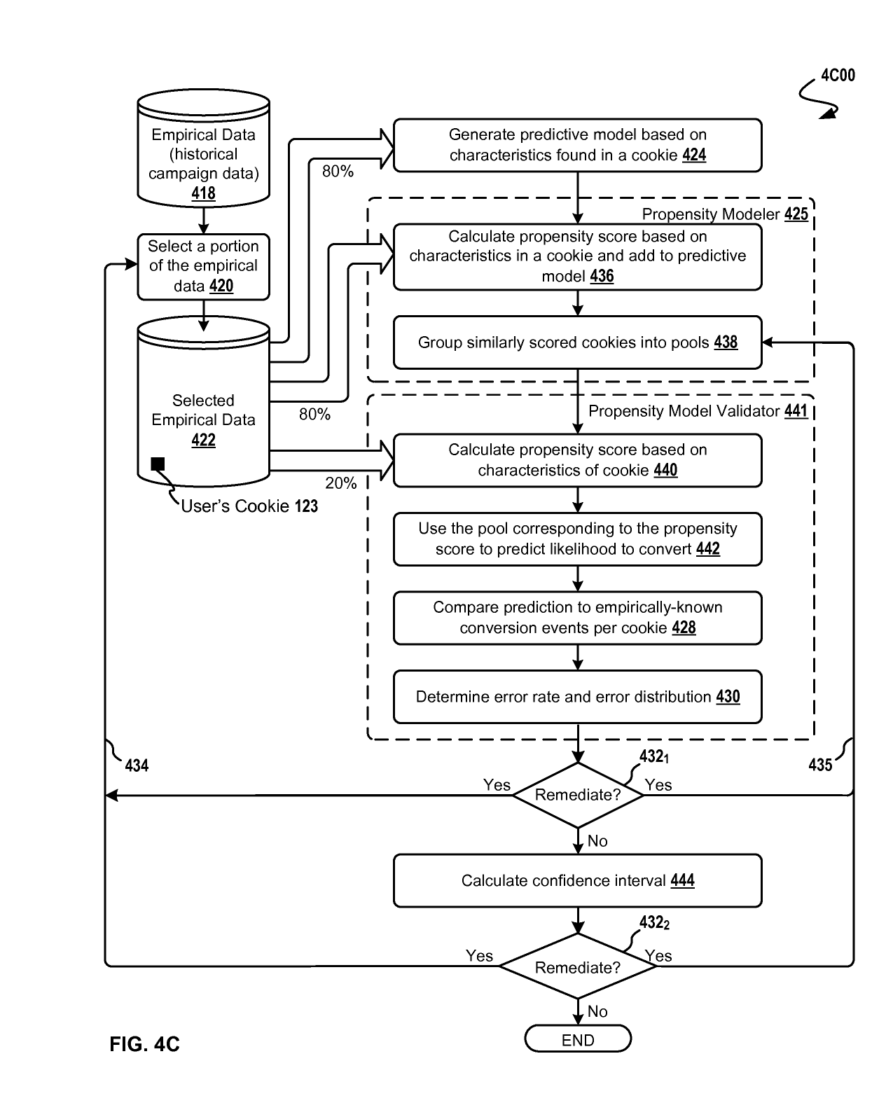

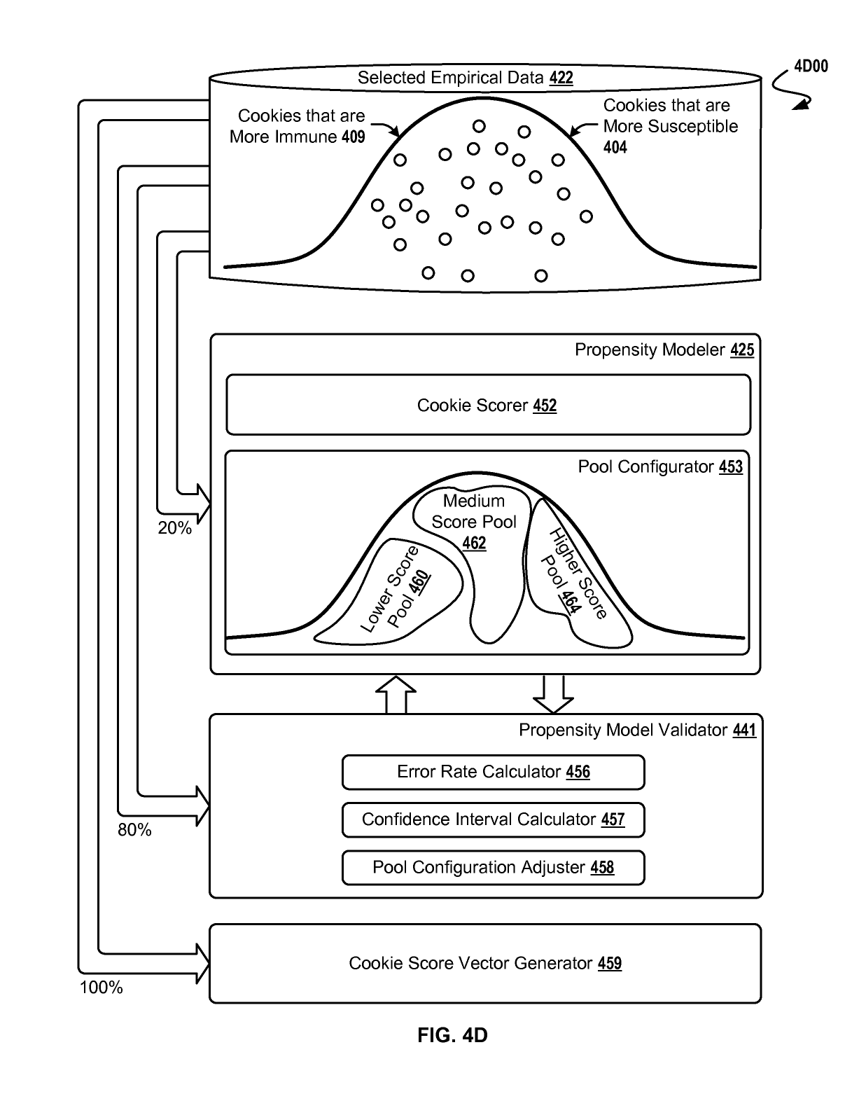

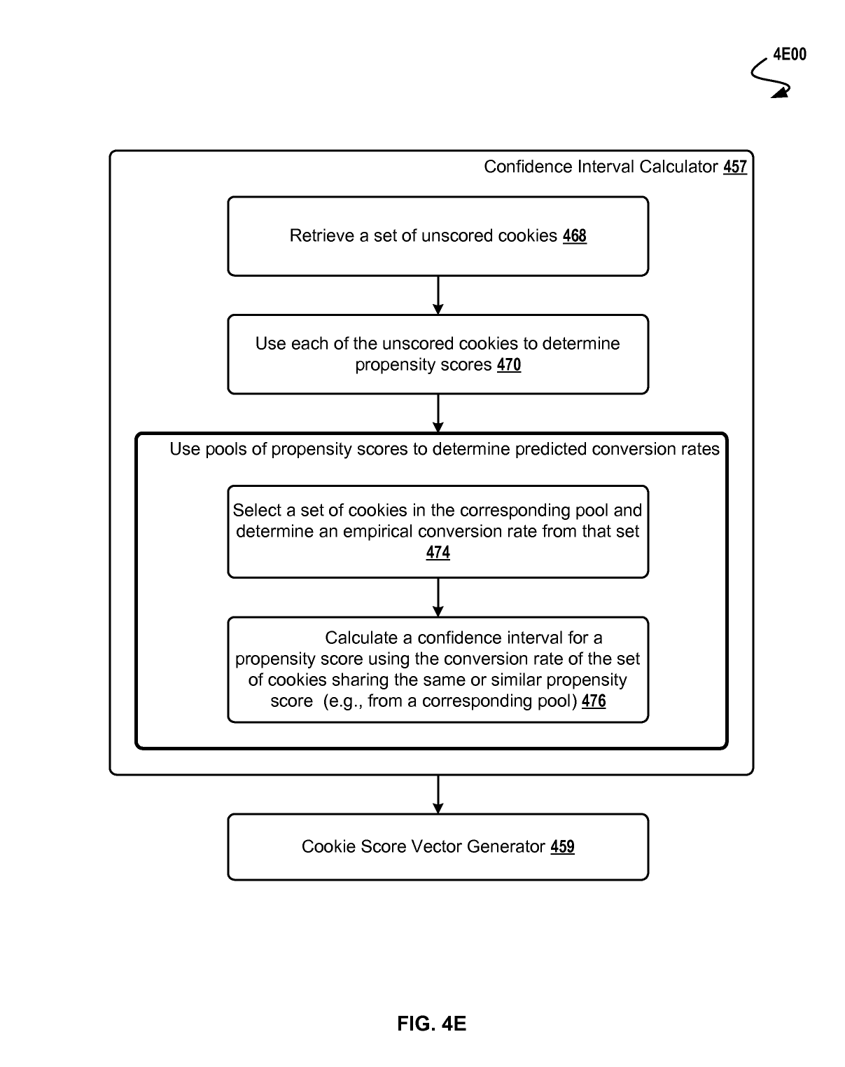

The shown flow 1B00 commences by selecting a touchpoint (e.g., corresponding to one of the cookies taken from the conversions). There may be many touchpoints involved in the prosecution of an advertising campaign, and any one or more of them may have made a calculable contribution to an empirically-determined conversion. In this flow, apportionment is determined at least in part on the contribution of a particular touchpoint with respect to the other touchpoints in the touchpoint stack. When a particular touchpoint has been selected (see operation 113), the flow accesses the user cookie database of the selected touchpoint (see operation 117). Each of the cookies in the cookie database (e.g., user's cookie 123) is individually scored, resulting in a conversion propensity score (see operation 119). Some embodiments use a learning model and predictor (see FIG. 4A). When a representative set of cookies have been scored such that the members of the representative set of cookies have a respective propensity score 121, a calculation determines how many of the representative set of cookies has a propensity score above a given threshold (see operation 125).

Certain embodiments include a partitioning that include a predictor 114. As shown, the propensity score is calculated based upon predictions or estimations output from a learning model, which in turn is based on a selection of empirically-determined conversions (e.g., populations of users who converted 111). User cookies are grouped into pools of similarly-scored cookies. At the time an advertisement or message is to be presented to a particular user, a prediction regarding conversion of that user can be made based on the likelihood of conversion of users with similar characteristics, attributes or traits. If the likelihood of conversion is deemed to be high, a particular advertisement or message might be selected. Strictly as one example, if the likelihood of conversion is deemed to be high, a message to incite action (e.g., a coupon) might be presented in lieu of a message to create awareness (e.g., a branding message).

FIG. 1C is a decision-making flow 1C00 to determine spending based on score and confidence thresholds as used in systems configured for generating statistically accurate user behavior predictions. As an option, one or more instances of decision-making flow 1C00 or any aspect thereof may be implemented in the context of the architecture and functionality of the embodiments described herein. Also, the decision-making flow 1C00 or any aspect thereof may be implemented in any desired environment.

As shown, the decision-making flow proceeds on the basis of making a decision to spend more (or less) based whether or not the particular user is likely to be responsive to a particular stimulus. In the case shown and described in FIG. 1C, the decision to spend more (or less) is partly based on the correlation between the particular subject user and other users that are similar to the particular subject user. Strictly as one example, a system using the decision-making flow 1C00 can know something about a particular user (e.g., possibly based on the user's cookie or combination of user cookies) and the system can know about the likelihood that certain stimulation will result in corresponding desired behavior based on the measured responses of other users that are similar to the particular subject user.

The flow commences by accessing the user's cookie 123 (see operation 124) and analyzes information accessed from the user's cookie. The cookie might contain a precalculated propensity score 121 that can be retrieved (e.g., see operation 126), or the user's cookie 123 might contain enough information to analyze to form a score (e.g., a propensity score 121). Or, in still other cases, some information in the cookie can be used as a key to retrieve a previously calculated score. Using the score, decision 128 is taken. If the information contained in the cookie or a retrieved score is deemed to be above a certain threshold (e.g., above a certain likelihood to convert), then the “Yes” branch of decision 128 is taken, and additional stimulation (e.g., presentation of additional media) need not be expended for this user at this moment in time (see operation 141). In some cases, even though a score is calculated to be above a certain threshold, it might be worth a second check to see if the score is associated with a high or low confidence. If the confidence is below a certain threshold, then a determination is made as to continue spending (e.g., present the impression) or not to continue spending (e.g., the presentation of the impression is suppressed). In still other cases, it might be deemed that the user has received enough stimulation (e.g., enough impressions of display ads) that the particular user is so likely to be responsive (e.g., make a “buy” decision) that no additional spending is warranted.

The flow of FIG. 1C and the heretofore logic can be used as a part of a protocol to implement a touchpoint that uses an ad server and cookie processor to take advantage of the availability of statistically accurate user behavior predictions when presenting advertisements or messages. In particular, such a protocol serves to determine if a particular user should receive additional stimulation and, if so, the protocol serves to attribute the impression and/or otherwise tally the delivery of the impression to the touchpoint.

FIG. 1D is a protocol 1D00 for using statistically accurate user behavior predictions. The cookie processor includes an instance of a model generator 110, which serves to generate a model (e.g., from historical, empirical data) and serves to pre-validate the predictive model such that the predictive model generates statistically accurate user behavior predictions. As an option, one or more instances of protocol 1D00 or any aspect thereof may be implemented in the context of the architecture and functionality of the embodiments described herein. Also, the protocol 1D00 or any aspect thereof may be implemented in any desired environment.

Referring again to the operational elements and the protocol 1D00 as shown, a cookie processor 146 implements a model generator 110 that generates a model from a history or stimuli and observations (see operation 162). The model is wrapped in a simulation wrapper (see operation 164) to form a predictive model. The predictive model is validated (see operation 166). The predictive model formation and validation steps use any of the herein-described techniques for showing (e.g., mathematically) that the precision and recall of the predictive model does indeed produce statistically accurate user behavior predictions (e.g., statistically accurate within a mathematically-provable confidence interval).

Message exchange in this protocol commences when a user 104 accesses a touchpoint 142 (see message 148). A message might come in the form of a click on a page or a touch or a swipe on a smartphone user interface. An occurrence of a message 148 might cause further interaction (see operation 150) with and/or at the touchpoint 142. In turn, touchpoint 142 might display additional content, which might motivate the user to further interact with the touchpoint (see operation 151), where such interaction might include a click or a touch (see user click of message 149). The touchpoint logic might seek to assess if the user 104 has a propensity to convert, and might then enter a protocol exchange (see fast decision-making exchange 155). To do so, the touchpoint will initiate a decision-making flow (see operation 153), which may in turn initiate a request to access the user's cookie (see message 154). User cookie data is retrieved (see message 157) and/or relayed to cookie processor 146 by delivery of the user's cookie data. The received cookie is used by the cookie processor to calculate a cookie score vector (see operation 168). The cookie score vector might comprise a propensity score and a confidence score corresponding to the aforementioned propensity score. The cookie score vector is returned to the caller (see message 170) in response to the request (see message 158).

Using the cookie score vector comprising at least a propensity score and a confidence score, the touchpoint will assess the propensity of the user (see operation 172) as well as assess the confidence interval of the user's propensity score (see operation 174). If the propensity score is above a propensity score threshold (see operation 175 and see FIG. 1C), and if the confidence score is above a confidence score threshold, then the touchpoint will request an ad from the ad server 144 (e.g., see message 176). The ad server will retrieve an applicable advertisement or other message (see operation 178) which in turn will deliver the advertisement (see message 180) in the form of an impression. The impression will be tallied, and the cost of the impression will be added to the account of the advertiser (see operation 184). In many cases, the confidence score is at or below a confidence score threshold, in which case the touchpoint will not request an ad from the ad server, and instead present only content (see message 181).

In exemplary cases, the time duration between the action of a user click or indication (see message 149) and delivery of the ad (see message 180) is on the order of hundreds of milliseconds. In some cases, a significant portion of the decision-making logic is hosted at the touchpoint. In other cases, portions of the decision-making logic are distributed between the touchpoint, the ad server, and the cookie processor. Fast decision-making is facilitated by a predictor subsystem that uses a precalculated predictor. An embodiment of a system for generating and validating a model to be used with a predictor subsystem is shown and discussed in FIG. 1E.

FIG. 1E presents a system 1E00 for generating and validating a model to be used with a predictor subsystem configured for generating statistically accurate user behavior predictions. As an option, one or more instances of system 1E00 or any aspect thereof may be implemented in the context of the architecture and functionality of the embodiments described herein. Also, the system 1E00 or any aspect thereof may be implemented in any desired environment.

As shown, a model generator 110 receives any forms of responses from users and/or from their interaction with the media campaign 106 (e.g., see user responses 108). The model generator 110 further receives any forms of stimulus as pertaining to the media campaign 106. The stimulus and responses can be scalars or can be vectors, and a particular stimulus can be correlated to one or more particular responses (see FIG. 4A). A learning model generated by the model generator can be validated using a model validator 112. Further, the model can be used in the context of a subsystem that includes interactive use of a predictor to make user behavior predictions.

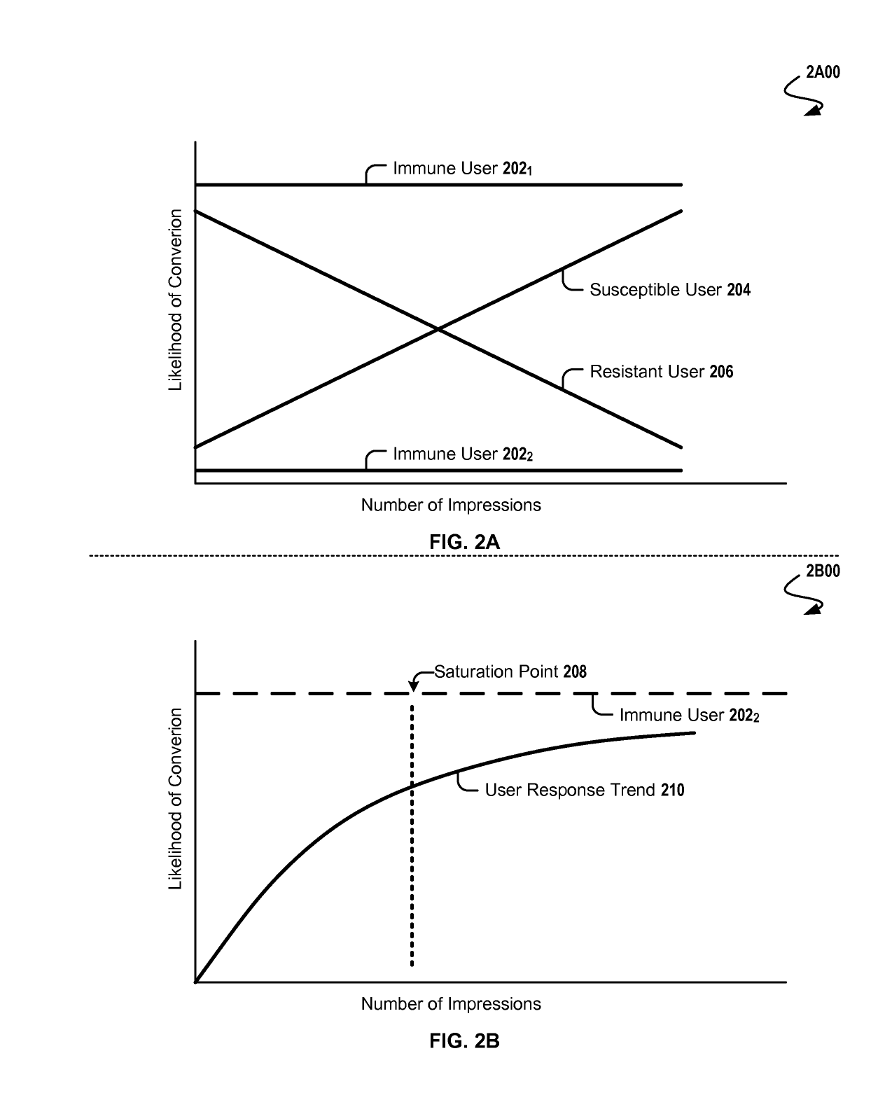

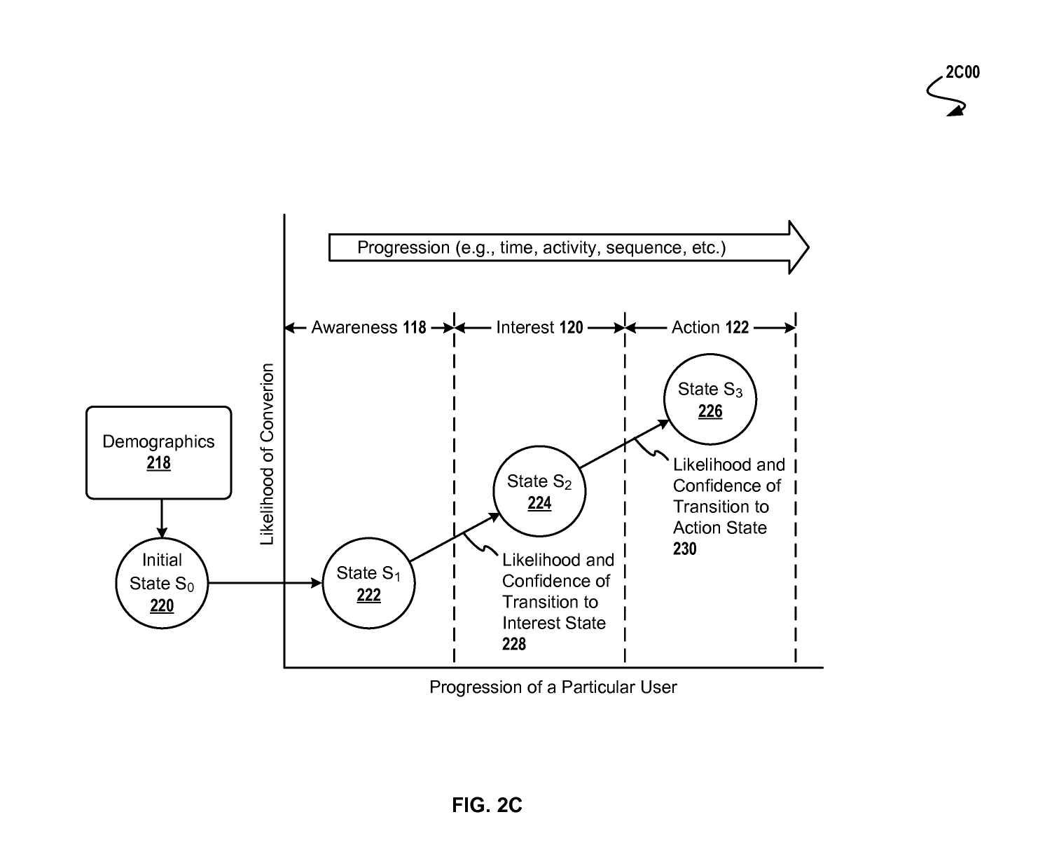

FIG. 2A is a user propensity chart 2A00 used in calibrating systems for generating statistically accurate user behavior predictions. As an option, one or more instances of user propensity chart 2A00 or any aspect thereof may be implemented in the context of the architecture and functionality of the embodiments described herein. Also, the user propensity chart 2A00 or any aspect thereof may be implemented in any desired environment.

The chart depicts a susceptible user 204, a resistant user 206, and immune users (e.g., immune user 202₁, and immune user 202₂). As is depicted in the chart, different users respond differently to stimulation. For example, some users (e.g., immune user 202₁) will not click an ad, will not buy a product, and will not take action toward a particular advertiser objective—regardless of the nature or extent of stimulation (e.g., number of impressions). Conversely, some users (e.g., immune user 202₂) meet a particular advertiser objective (e.g., make a “buy” decision) regardless of the nature or extent of stimulation. Other users respond relatively favorably to additional stimulation (e.g., susceptible user 204) and still other users respond relatively unfavorably to additional stimulation (e.g., resistant user 206).

The behavior of a user vis-à-vis a number of delivered impressions, and/or the behavior of a set of users in aggregate vis-à-vis number of delivered impressions, can be used to calibrate a media campaign. For example, the behavior of a user vis-à-vis a number of delivered impressions can be used in calculating a propensity score 121. In some cases, a situation of diminishing returns emerges. Such a point or region of diminishing returns can be depicted by plotting the likelihood of conversion as a function of the number of impressions over an aggregation of users. The phenomenon of diminishing return is discussed as follows.

FIG. 2B is a diminishing returns chart 2B00 for modeling user behavior changes over time as used for calibrating systems capable of generating statistically accurate user behavior predictions. As an option, one or more instances of diminishing returns chart 2B00 or any aspect thereof may be implemented in the context of the architecture and functionality of the embodiments described herein. Also, the diminishing returns chart 2B00 or any aspect thereof may be implemented in any desired environment.

The shown user response trend 210 has an inflection point (e.g., for example, the shown saturation point 208), beyond where the user's propensity to convert does not increase as fast as before reaching the saturation point. In some cases, an advertiser would want to stop showing ads to such a user and/or would want to decrease the rate at which ads are shown to such a user. The curve shown as user response trend 210 and the point of inflection (or any other selected point) can be used to calibrate any modules that calculate or use a propensity score.

FIG. 2C is a state progression chart 2C00 showing user progression over time as is used for calibrating systems capable of generating statistically accurate user behavior predictions. As an option, one or more instances of state progression chart 2C00 or any aspect thereof may be implemented in the context of the architecture and functionality of the embodiments described herein. Also, the state progression chart 2C00 or any aspect thereof may be implemented in any desired environment.

The chart 2C00 depicts a user's likelihood of conversion as a function of time. More specifically, the chart depicts a user's likelihood of conversion as a function of a time-wise progression through states (e.g., state S1 222, state S2 224, and state S3 226). As shown, the states correspond to user awareness 118, interest 120, and action 122. The likelihood of conversion can be granular. For example, there can be a likelihood and confidence of a transition to interest state S2 (see transition 228) and/or there can be a likelihood and confidence of a transition to action state S3 (see transition 230).

A likelihood of conversion can be codified as a propensity score. A propensity score need not be strictly linear. For example, while the shown state S3 is only slightly higher that the state S2 (e.g., see the ordinate likelihood of conversion scale), a propensity score corresponding to S3 might be significantly higher than a propensity score corresponding to S2. Moreover, a state progression can be formulated for a particular user or for a particular set of demographics 218. A set of demographics (e.g., user-specific demographics pertaining to a particular set of user demographics pertaining to an aggregation of users) can be initially populated into an initial state S0 220. The form of demographics 218 as shown can be derived using any known techniques.

An advertiser or media campaign manager might calibrate a propensity score and/or any of the constituents of a cookie score vector using a chart such as the depicted chart 2C00.

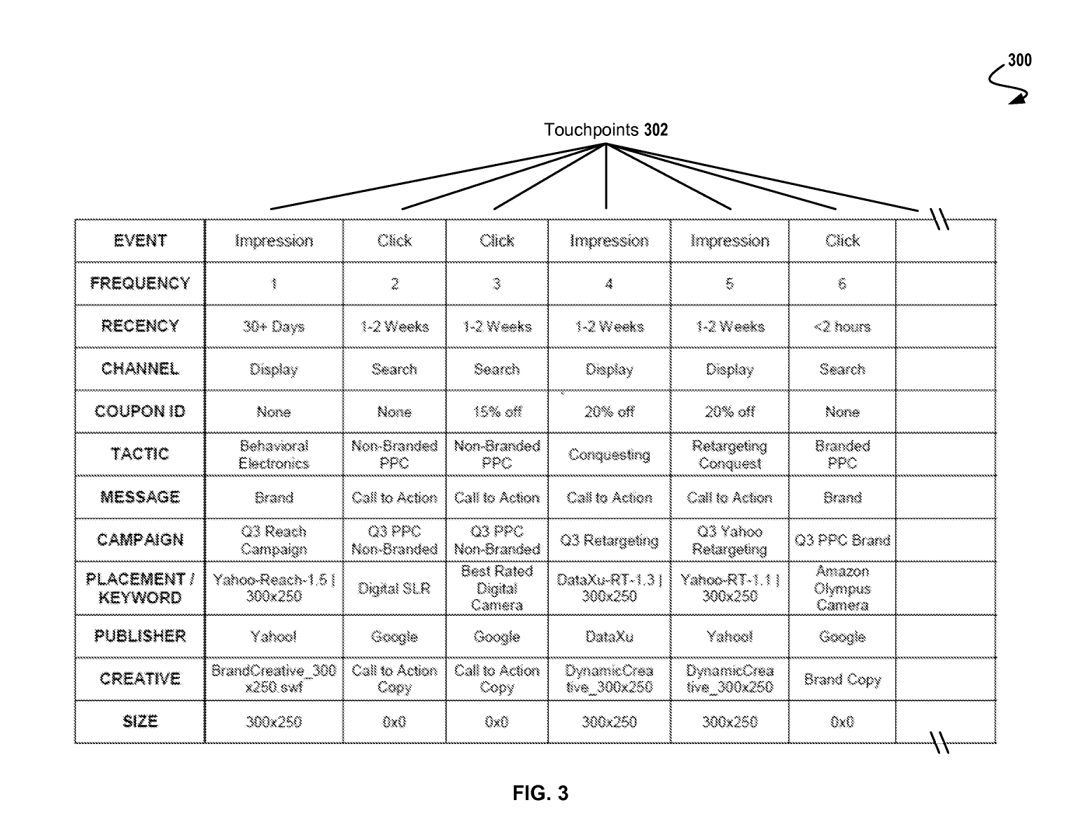

FIG. 3 is a touchpoint attribute chart 300 showing sample attributes associated with sample touchpoints as used in systems capable of generating statistically accurate user behavior predictions. As an option, one or more instances of touchpoint-attribute chart 300 or any aspect thereof may be implemented in the context of the architecture and functionality of the embodiments described herein. Also, the touchpoint-attribute chart 300 or any aspect thereof may be implemented in any desired environment.

As discussed herein, a touchpoint can be embodied as an internet destination, or can be embodied as an event. In exemplary cases a touchpoint is any occurrence where a user and any aspect of a media campaign interact. In many of the systems discussed herein, there is a measurable relationship between a touchpoint and a conversion, and a media manager might use such measurements to make decisions as to channel spending and media mix etc. so as to increase the occurrence of conversions. In some cases a particular progression through touchpoints can be shown to be particularly effective to achieve some desired response (e.g., the user makes a “buy” decision). Indeed, the correlation of touchpoints to conversions and/or specific progressions through a set of touchpoints can be observed and analyzed for presentation to an advertiser or media manager.

FIG. 3 shows several touchpoints 302 associated with a conversion, and the touchpoints comprise one or more attributes. The example dataset of FIG. 3 correlates the various touchpoints with a plurality of attributes associated with respective touchpoints. Specifically, the first column (column0) identifies the attribute, and columns 1-6 identify attribute values for attributes of column0) for various touchpoints. For example, the first attribute (row0) identifies the type of event for the touchpoint. The first touchpoint (column1) was an impression presented to the user, while the second and third touchpoints (columns 2 and3) were items the user clicked on. Similarly, the other entries of the table of FIG. 3 identify attribute values for the attributes of column0) for the various touchpoints.

FIG. 4A exemplifies a model generation flow 4A00 resulting in a predictor capable of generating statistically accurate user behavior predictions. As an option, one or more instances of model generation flow 4A00 or any aspect thereof may be implemented in the context of the architecture and functionality of the embodiments described herein. Also, the model generation flow 4A00 or any aspect thereof may be implemented in any desired environment.

As shown, stimulus vectors S1 through SN are collected, and response vectors R1 through RN are collected and organized into one-to-one pairings (see operation 402). A portion of the collected pairs (e.g., pairs S1R1 through S3R3) can be used to train a learning model (see operation 404). A different portion of the collected pairs (e.g., pairs S4R4 through S6R6) can be used to validate the learning model (see operation 406₁ and operation 406₂). The process of training and validating can be iterated (see path 412), for example, to define the constituent features in any of the collected pairs and/or to develop intra-model correlations so as to achieve a desired degree of precision and recall.

If the model generator deems there is insufficient confidence in the model (see decision 408) then path 414 can be taken to collect additional stimulus-response pairs. If the model generator deems there is sufficient confidence in the model (see decision 408) then the model can be packaged to be used as a predictor (see operation 410).

The techniques of FIG. 4A can be used to generate a predictive model for predicting a user's likelihood to convert. More particularly, any of the validation techniques used to validate the learning model (e.g., operation 406₁ and operation 406₂) can include error-rate determination techniques and propensity score pools as are shown and discussed as pertaining to the following FIG. 4B and FIG. 4C.

FIG. 4B exemplifies a model validation flow 4B00 for comparing predictors capable of generating statistically accurate user behavior predictions. As an option, one or more instances of model validation flow 4B00 or any aspect thereof may be implemented in the context of the architecture and functionality of the embodiments described herein. Also, the model validation flow 4B00 or any aspect thereof may be implemented in any desired environment.

As shown, the model validation flow 4B00 commences by selecting a portion of the empirical data (see operation 420). The storage device 418 holds empirical data that can come from a previously-prosecuted campaign, or it can come from a portion of a campaign in progress.

Using any portions or aspects of the techniques of FIG. 4A, the model validation flow 4B00 generates a predictive model based on attributes found in user cookies (see operation 424). As shown, 80% of the selected empirical data 422 is used to generate the predictive model, and 20% is used for comparing response predictions of the predictive model (see operation 426) against empirically-known responses to the same stimulus (see operation 428). The error rate over the 20% of the selected empirical data can be measured using any known techniques (see operation 430), and the error rate can be tested (see decision 432). If the error rate is too high, then path 434 can be taken to select additional empirical data.

In some cases, the error rate remains too high, even after selecting additional empirical data points, and in some cases, the error distribution is unacceptably wide, even after selecting additional empirical data points. Error rate and error distribution can be improved using the techniques herein, in particular, the error rate and error distribution can be improved using the techniques of the following FIG. 4C.

FIG. 4C exemplifies a predictor validation system 4C00 using propensity score pools for generating statistically accurate user behavior predictions. As an option, one or more instances of predictor validation system 4C00 or any aspect thereof may be implemented in the context of the architecture and functionality of the embodiments described herein. Also, the predictor validation system 4C00 or any aspect thereof may be implemented in any desired environment.

Further details related to formation and use of a propensity score are disclosed in U.S. patent application Ser. No. 14/465,838, entitled “APPORTIONING A MEDIA CAMPAIGN CONTRIBUTION TO A MEDIA CHANNEL IN THE PRESENCE OF AUDIENCE SATURATION” filed on Aug. 22, 2014, the content of which is incorporated by reference in its entirety in the present application.

The depiction of the predictor validation system 4C00 includes a propensity modeler 425 and a propensity model validator 441. The propensity modeler includes steps to calculate a propensity score based on attributes found in the user cookies (e.g., user's cookie 123). The score is added to the predictive model (see operation 436).

The propensity modeler 425 further includes steps to group identically- or similarly-scored propensity scores into pools (see operation 438, and see the following FIG. 4D). The model generated by propensity modeler 425 is then validated using a portion of the selected empirical data.

As shown, the propensity model validator 441 uses 20% of the selected empirical data (see operation 440), however other portions are possible. The propensity score is calculated from selected empirical data and is compared with the pools of similarly-scored cookies as were generated by the propensity modeler 425. The propensity model validator uses the likelihood of conversion of the corresponding pool (see operation 442) in comparing the conversion prediction of the propensity model to the empirically-known conversions. The error rate and error distribution are calculated (see operation 430) and the quality of the model is checked against a model quality threshold (e.g., precision and recall measures). If the quality of the model is measured to be too low 432₁, then path 434 can be taken and additional data is selected. In some situations, if the quality of the model is measured to be too low, path 435 is taken and the makeup of the pools is adjusted.

Continuing, when the quality of the model is deemed to be high enough, the predictor validation system 4C00 proceeds to calculate the confidence interval for the predictions (see operation 444). If the confidence interval for the predictions is deemed to be too low (see decision 432₂), then path 434 can be taken, and additional data is selected. In some situations, if the confidence interval for the predictions is deemed to be too low (e.g., below a threshold value or outside of a threshold range), path 435 is taken and the makeup of the pools is adjusted.

In some embodiments, the cookies can be retrieved from the operators of touchpoints, and the validation of the model can proceed as follows:
Receive a plurality of cookies from a plurality of touchpoint operators (e.g., where a cookie includes aspects of user encounters at the corresponding touchpoint);
Identify, from the plurality of converter cookies, those cookies corresponding to known conversions (e.g., conversions as reported by the last of a succession of touchpoint encounters);
Parse the cookies to determine quantifiable characteristics of the touchpoint encounters; then,
Select a first portion of the cookies (e.g., 80%), and use the converter cookies to identify a plurality of quantifiable characteristics corresponding to the conversion (or non-conversion);
Calculate a propensity score for each cookie using the quantifiable characteristics;
Generate a prediction model using a second portion (e.g., 20%) of the cookies and the calculated propensity scores; and
Validate the accuracy of the prediction model by comparing the conversions associated with the first portion of the cookies to the predictions of the prediction model based on the second portion of cookies.

In some cases, the prediction model (e.g., a model based on the learning model) can be used to apportion a campaign spending amount (e.g., in dollars or another currency) to one or more of the touchpoints. In some cases, the prediction model can be used to determine a remuneration amount (e.g., in dollars or another currency) to be paid to operators of the one or more respective touchpoints.

FIG. 4D depicts a subsystem 4D00 including a confidence interval calculator as used in systems for generating statistically accurate user behavior predictions. As an option, one or more instances of subsystem 4D00 or any aspect thereof may be implemented in the context of the architecture and functionality of the embodiments described herein. Also, the subsystem 4D00 or any aspect thereof may be implemented in any desired environment.

As shown, the selected empirical data 422 comprises cookies that are more immune 409 (e.g., cookies that belong to users who are more immune) as well as cookies that are more susceptible (e.g., cookies that belong to users who are more susceptible), as well as cookies that fall in the middle. The propensity modeler 425 uses a cookie scorer 452 and a pool configurator 453 to generate propensity pools. More specifically, the pool configurator 453 forms pools of similarly-scored cookies based on propensity scores generated by the cookie scorer 452. The propensity pools as shown in FIG. 4D comprise three pools (e.g., lower score pool 460, higher score pool 464, and medium score pool 462), however exemplary embodiments of the pool configurator 453 may generate more (or fewer) pools at any level of granularity. For example a pool may be formed to comprise cookies having a wide range of values or, for example, a pool may be formed to comprise cookies having a narrow range of values.

Once pools are formed, the propensity model validator 441 can begin assessing the predictive model based on the pools as formed. Strictly as an example, the propensity model validator can comprise of an error rate calculator 456, a confidence interval calculator 457, and a pool configuration adjuster 458.

The error rate calculator 456 and the confidence interval calculator 457 operate over the same cookie or set of cookies, and a low error rate and/or an out-of-spec confidence interval value can trigger operations to adjust the pool. Accordingly, paths into and out of the propensity modeler 425 are provided.

Once the propensity model validator has completed (e.g., has processed its portion of the empirical data), a cookie score vector generator 459 can be invoked to retrieve all of the cookies from the selected empirical data, and a cookie score vector generator is invoked to create the cookie score vectors as are used (for example) in a protocol 1D00 during the course of attributing impressions to media touchpoints.

FIG. 4E depicts a subsystem 4E00 including a confidence interval calculator as used in systems for generating statistically accurate user behavior predictions. As an option, one or more instances of subsystem 4E00 or any aspect thereof may be implemented in the context of the architecture and functionality of the embodiments described herein. Also, the subsystem 4E00 or any aspect thereof may be implemented in any desired environment.

Operations within the shown confidence interval calculator 457 commence upon retrieving a set of unscored cookies (see operation 468) and then uses the unscored cookies to determine propensity scores (see operation 470). A calculated propensity score can be used in combination with propensity pools in order to improve the precision and recall of the predictor. For example, and as shown:
A first operation selects a set of cookies in the corresponding pool and determines an empirical conversion rate (e.g., a median conversion rate) for that set taken from the pool (see operation 474). In some cases all members in a pool are selected into the aforementioned set.
A second operation calculates a confidence interval for a propensity score using the conversion rate of the pool of cookies sharing the same or similar propensity score (see operation 476).

Processing proceeds, and an instance of a cookie score vector generator 459 is invoked with a given cookie. A cookie score vector is constructed for the given cookie. As earlier indicated, the time duration between the user click or touch or other user indication (see message 149 of FIG. 1D) and delivery of the ad (see message 180) is on the order of hundreds of milliseconds. The operation or operations within instances of a cookie score vector generator 459 might be implemented so as to start and finish within that time frame. Any known techniques (e.g., indexing, caching, etc.) can be used when implementing a cookie score vector generator 459.

### Additional Practical Application Examples

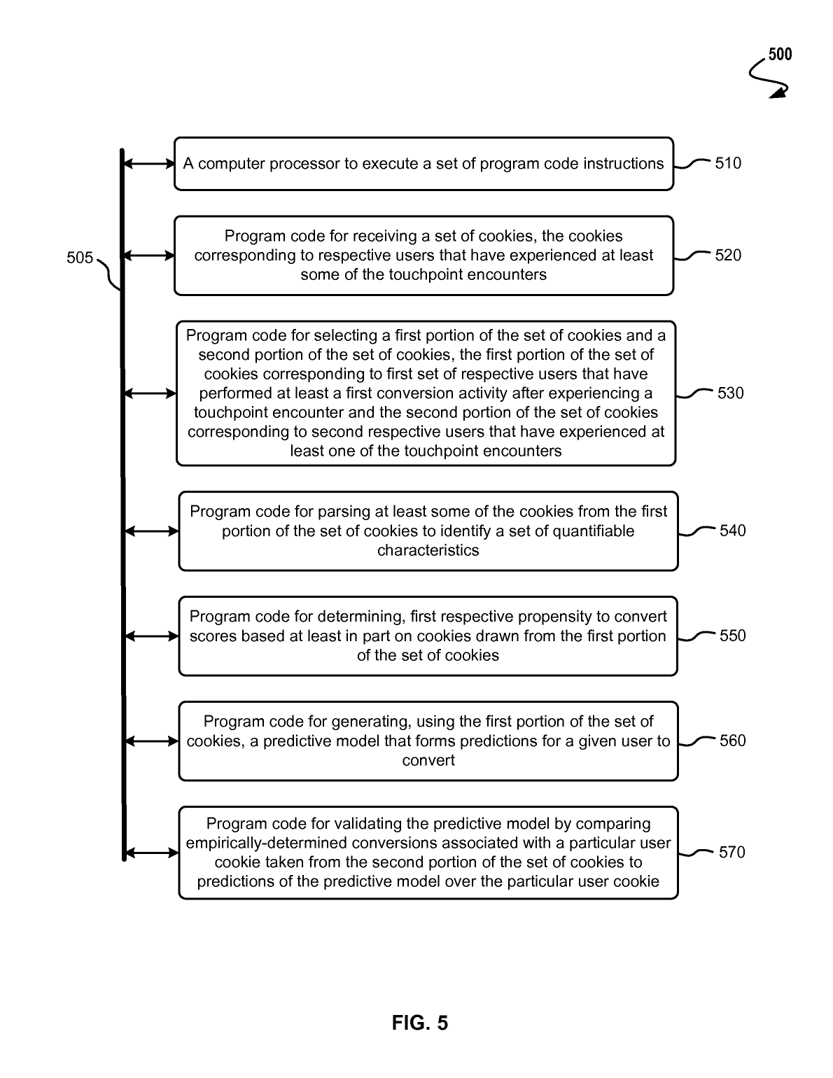

FIG. 5 is a block diagram of a system for generating statistically accurate user behavior predictions, according to some embodiments. As an option, the present system 500 may be implemented in the context of the architecture and functionality of the embodiments described herein. Of course, however, the system 500 or any operation therein may be carried out in any desired environment.

The system 500 comprises at least one processor and at least one memory, the memory serving to store program instructions corresponding to the operations of the system. As shown, an operation can be implemented in whole or in part using program instructions accessible by a module. The modules are connected to a communication path 505, and any operation can communicate with other operations over communication path 505. The modules of the system can, individually or in combination, perform method operations within system 500. Any operations performed within system 500 may be performed in any order unless as may be specified in the claims.

The shown embodiment implements a portion of a computer system, shown as system 500, comprising a computer processor to execute a set of program code instructions (see module 510) and modules for accessing memory to hold program code instructions to perform: receiving a set of cookies, the cookies corresponding to respective users that have experienced at least some of the touchpoint encounters (see module 520); selecting a first portion of the set of cookies and a second portion of the set of cookies, the first portion of the set of cookies corresponding to first set of respective users that have performed at least a first conversion activity after experiencing a touchpoint encounter and the second portion of the set of cookies corresponding to second respective users that have experienced at least one of the touchpoint encounters (see module 530); parsing at least some of the cookies from the first portion of the set of cookies to identify a set of quantifiable characteristics (see module 540); determining, first respective propensity to convert scores based at least in part on cookies drawn from the first portion of the set of cookies (see module 550); generating, using the first portion of the set of cookies, a predictive model that forms predictions for a given user to convert (see module 560); and validating the predictive model by comparing empirically-determined conversions associated with a particular user cookie taken from the second portion of the set of cookies to predictions of the predictive model over the particular user cookie (see module 570).

Many variations are possible. For example, in an exemplary method flow, the steps for validating a predictive model based on empirically-determined data taken from one or more touchpoint encounters includes:
receiving a set of cookies, where the cookies correspond to respective users that have experienced at least some of the touchpoint encounters;
selecting a first portion of the set of cookies and a second portion of the set of cookies, where the first portion of the set of cookies corresponds to first set of respective users that have performed at least a first conversion activity after experiencing a touchpoint encounter and the second portion of the set of cookies corresponds to second respective users that have experienced at least one of the touchpoint encounters;
parsing at least some of the cookies from the first portion of the set of cookies to identify a set of quantifiable characteristics;
determining, first respective propensity to convert scores based at least in part on cookies drawn from the first portion of the set of cookies;
generating, using the first portion of the set of cookies, a predictive model that forms predictions for a given user to convert; and
validating the predictive model by comparing empirically-determined conversions associated with a particular user cookie taken from the second portion of the set of cookies to predictions of the predictive model over the particular user cookie.

Various embodiments can be implemented using special-purpose hardware to perform calculations and/or to receive and/or to store massive amounts of data.

### Additional System Architecture Examples

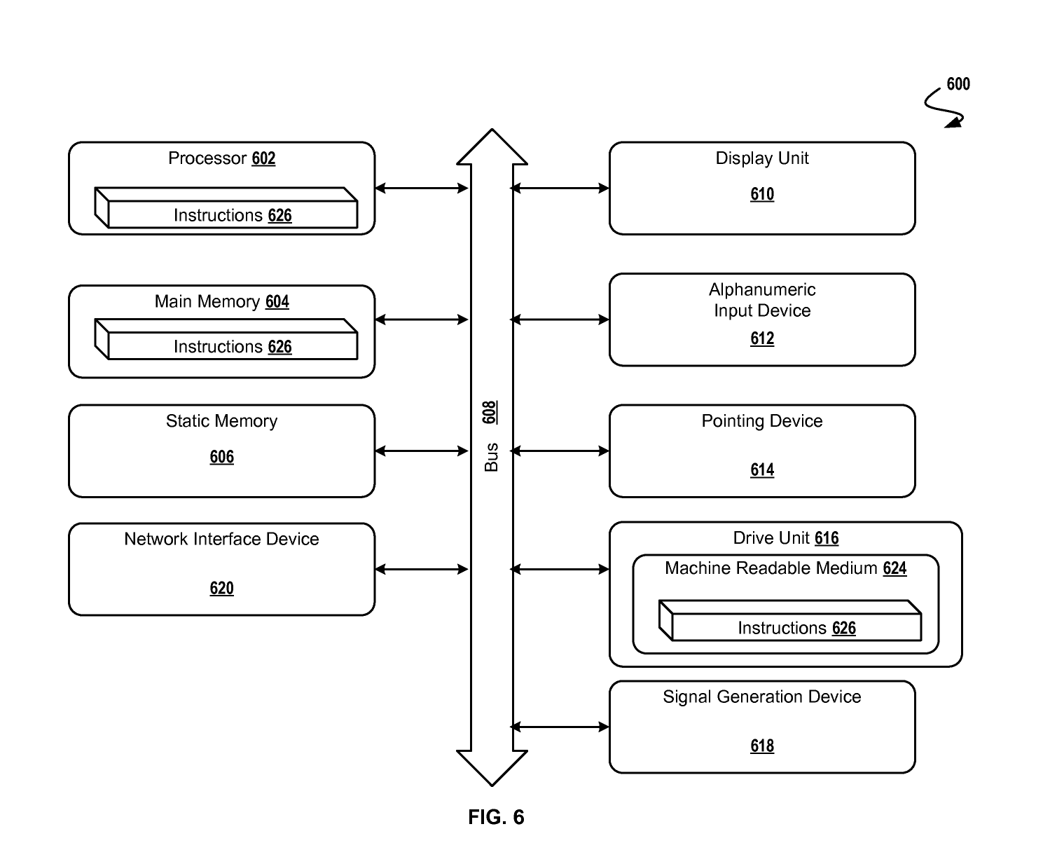

FIG. 6 depicts a diagrammatic representation of a machine in the exemplary form of a computer system 600 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 600 includes a processor 602, a main memory 604 and a static memory 606, which communicate with each other via a bus 608. The computer system 600 may further include a video display unit 610 (e.g., an LED display, or a liquid crystal display (LCD) or a cathode ray tube (CRT)). The computer system 600 also includes an alphanumeric input device 612 (e.g., a keyboard), a pointing device 614 (e.g., a mouse), a disk drive unit 616, a signal generation device 618 (e.g., a speaker), and a network interface device 620.

The disk drive unit 616 includes a machine-readable medium 624 on which is stored a set of instructions 626 (e.g., software) embodying any one, or all, of the methodologies described above. The instructions 626 are also shown to reside, completely or at least partially, within the main memory 604 and/or within the processor 602. The instructions 626 may further be transmitted or received via the network interface device 620.

The computer system 600 can be used to implement a client system and/or a server system and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as a processor 602.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method for validating attribution of advertising touchpoints to conversions, the computer implemented method comprising:
receiving, by a computer, a set of records comprising plurality of touchpoint encounters and a plurality of conversions correlated to a plurality of users, wherein the touchpoint encounters comprise a plurality of attributes and the attributes comprise a plurality of attribute values;
determining, from a first portion of the touchpoint encounters, the conversions and the users, a plurality of quantifiable characteristics corresponding to the touchpoint encounters;
determining, using a plurality of users from the first portion, a plurality of respective propensity scores using the quantifiable characteristics;
generating, using a second portion of the touchpoint encounters, the conversions and the users, predictions for propensity to convert; and
validating the predictions by comparing the conversions associated with the first portion of the touchpoint encounters to the predictions for propensity to convert.

2. The method of claim 1, wherein a cookie defines the touchpoint encounter.

3. The method of claim 1, wherein at least some of the plurality of touchpoint encounters are used to form a learning model.

4. The method of claim 3, wherein the learning model comprises a selection of empirically-determined conversions.

5. The method of claim 3, further comprising calculating at least some of the plurality of propensity scores based at least in part on the predictions that are output from a learning model.

6. The method of claim 3, further comprising using the learning model to determine a spending apportionment based at least in part on the plurality of touchpoint encounters.

7. The method of claim 3, further comprising using the learning model to determine a remuneration amount.

8. The method of claim 1, further comprising calculating a confidence interval for the predictions.

9. The method of claim 8, further comprising determining if the confidence interval is lower than a threshold value of outside of a threshold range.

10. The method of claim 9, further comprising forming a pool of cookies based at propensity scores of individual cookies when the confidence interval is lower than a threshold value of outside of a threshold range.

11. A computer program product embodied in a non-transitory computer readable medium, the computer readable medium having stored thereon a sequence of instructions which, when executed by a processor causes the processor to execute a process, the process comprising:
receiving a set of records comprising plurality of touchpoint encounters and a plurality of conversions correlated to a plurality of users, wherein the touchpoint encounters comprise a plurality of attributes and the attributes comprise a plurality of attribute values;
determining, from a first portion of the touchpoint encounters, the conversions and the users, a plurality of quantifiable characteristics corresponding to the touchpoint encounters;
determining, using a plurality of users from the first portion, a plurality of respective propensity scores using the quantifiable characteristics;
generating, using a second portion of the touchpoint encounters, the conversions and the users, predictions for propensity to convert; and
validating the predictions by comparing the conversions associated with the first portion of the touchpoint encounters to the predictions for propensity to convert.

12. The computer program product of claim 11, wherein a cookie defines the touchpoint encounter.

13. The computer program of claim 11, wherein at least some of the plurality of touchpoint encounters are used to form a learning model.

14. The computer program of claim 13, wherein the learning model comprises a selection of empirically-determined conversions.

15. The computer program of claim 13, further comprising calculating at least some of the plurality of propensity scores based at least in part on the predictions that are output from a learning model.

16. The computer program of claim 13, further comprising using the learning model to determine a spending apportionment based at least in part on the plurality of touchpoint encounters.

17. The computer program of claim 13, further comprising using the learning model to determine a remuneration amount.

18. The computer program of claim 11, further comprising calculating a confidence interval for the predictions.

19. A computer system comprising:
a storage device having at least one area to hold a set of records comprising plurality of touchpoint encounters and a plurality of conversions correlated to a plurality of users, wherein the touchpoint encounters comprise a plurality of attributes and the attributes comprise a plurality of attribute values;
a memory to hold at least a portion of the set of records; and
a computer processor to execute a set of program code instructions to perform steps of,
determining, from a first portion of the touchpoint encounters, the conversions and the users, a plurality of quantifiable characteristics corresponding to the touchpoint encounters;
determining, using a plurality of users from the first portion, a plurality of respective propensity scores using the quantifiable characteristics;
generating, using a second portion of the touchpoint encounters, the conversions and the users, predictions for propensity to convert; and
validating the predictions by comparing the conversions associated with the first portion of the touchpoint encounters to the predictions for propensity to convert.

20. The system of claim 19, wherein a cookie defines the touchpoint encounter.
